(19) United States
(12) Patent Application Publication
(10) Pub. No.: US 2022/0024072 A1
(43) Pub. Date: Jan. 27, 2022

(54) ADJUSTMENT DEVICE FOR MACHINES FOR CUTTING FLOOR TILES AND SIMILAR

(71) Applicant: GERMANS BOADA, S.A., Rubi (ES)

(72) Inventor: Jesús GONZÁLEZ GARCÍA, Rubi (ES)

(21) Appl. No.: 17/493,804

(22) Filed: Oct. 4, 2021

Related U.S. Application Data
(63) Continuation of application No. PCT/ES2019/070809, filed on Nov. 27, 2019.

(51) Int. Cl. B28D 1/04

(52) U.S. Cl. CPC B28D 1/047

(57) ABSTRACT

The invention relates to an adjustment device for machines for cutting floor tiles and similar, which is provided with a base (1) and an arm (2) carrying a head with a cutting disc (5), and which comprises an adjustment bolt (3) rotatably mounted on the base and provided with a cam (33) that acts against the inner contour of a square hole (21), the cam (33) having a profile suitable to cause, by means of the rotation of the adjustment bolt (3), the arm (2) to move along a square path (T) and the cutting disc (5) to be adjusted in two directions (x, y), parallel and perpendicular to the longitudinal direction (x) of the base.

### CROSS-REFERENCE TO RELATED APPLICATION

This application is a continuation of International Application No. PCT/ES2019/070809, filed Nov. 27, 2019, the entire disclosure of which is incorporated herein by reference.

### TECHNICAL FIELD

The invention relates to an adjustment device for machines for cutting floor tiles and similar, which is applicable in electrical machines for cutting floor tiles and similar construction parts, and which have a base on which the floor tiles to be cut move in a longitudinal direction and an arm carrying a head with a cutting disc.

### BACKGROUND

At present, it is a common practice to market properly disassembled and packaged machines, and with an instruction manual so that the user can assemble and use them.

These machines include electrical cutters for cutting floor tiles and construction materials, which have a base on which the floor tiles to be cut move, for example, by means of a reciprocating carriage in a longitudinal direction, and an arm that is fixed on said base and carries a head provided with a cutting disc and the corresponding electric motor to drive it.

The mounting on the base of the arm carrying the cutting head is carried out by means of a suitable adjustment device for adjusting the position of the arm until the cutting disc is centered on the base and located in a plane coinciding with the longitudinal cutting direction of the floor tiles; the object of this invention specifically being an adjustment device having the aforementioned purpose.

The state of the art closest to the present invention is described in document U.S. Pat. No. 9,707,700 which relates to a power tool, specifically a tile saw of the type mentioned above and comprising: a base; a table movably coupled to the base and movable along an axis in a first plane between a first position and a second position to cut a workpiece; a blade assembly having a saw blade rotatable within a second plane, perpendicular to the first plane, to cut the workpiece as the table moves between the first position and the second position; a support arm fixedly coupling the blade assembly to the base via a support arm mount; and an adjustment mechanism received by the support arm mount and movable between a first adjustment position and a second adjustment position to adjust the position of the saw blade.

In this adjustment mechanism, the use of an adjustment bolt mounted on the base and provided with a cam with a circumferential profile, which acts during the rotating movement thereof against the inner contour of elongated grooves defined in the arm, causes said arm to be displaced in the thrust direction of the cam, i.e., in a changing radial direction; the intervention of second elongated grooves, perpendicular to those mentioned above, being required to enable a play of the arm in the horizontal plane, and the centering of the disc.

This adjustment mechanism enables the arm to be displaced in the x-y plane with circumferential movement, relatively slow but enabling, by means of an uneven rotation of the adjustment bolts arranged on the opposite sides of the arm, said arm to be slightly tilted so that the cutting disc is not perfectly aligned with the longitudinal direction of the base, on which the floor tiles must be cut.

Therefore, this adjustment mechanism is an aid for the user when changing the position of the arm, but the adjustment depends on the user's skill and does not ensure that the disc is perfectly aligned with the longitudinal direction of the base.

### SUMMARY

The adjustment device for machines for cutting floor tiles and similar, object of this invention, is applicable to electrical machines for cutting floor tiles, provided with a base on which the floor tiles to be cut move in the longitudinal direction and an arm carrying a head with a cutting disc.

This adjustment device is of the type described in the preamble of the main claim, i.e., that incorporates an adjustment bolt comprising a cylindrical lower section rotatably mounted in a hole in the base with respect to a first axis perpendicular to the base; a cam defined in an intermediate area of the bolt and which acts against the inner contour of a hole defined in the arm carrying the head, the rotation of the cam causing the arm to move around the said first axis for centering the blade with the base of the machine, and, a threaded upper section, aligned with the cylindrical lower section and protruding at the top from the arm for mounting a fastening nut for fastening the arm to the adjustment bolt in different relative positions.

This adjustment device has constructive features aimed at facilitating a correct positioning of the arm with respect to the base and ensuring the displacement of said arm, and therefore of the cutting disc, in two perpendicular positions, one of them parallel and the other perpendicular to the longitudinal direction of the base, by simply rotating adjustment bolts mounted on the base, parallel to the longitudinal direction of said base.

Therefore, this device does not require the user to have a special skill, nor does it require the use of elongated grooves in two opposite directions to adjust the position of the arm on the plane of the base.

For this, and according to the invention, the hole in the arm that contains the cam is a square hole, i.e., a hole with a square section, and the cam has a symmetrical profile, inscribed in the square section of the hole in the arm, formed by two curved sectors of different curvature and with the axis thereof displaced towards the vertex of the curved sector of greater curvature; said cam having a length in the direction of the axis of symmetry thereof, and a width in a direction perpendicular to the axis of symmetry thereof, both equal to the side of the aforementioned square hole; such that the rotation of the adjustment bolt causes the arm to move along a square path and the disc to be adjusted in two directions (x, y) parallel and perpendicular to the longitudinal direction of the base.

These features ensure that the displacement of the arm, and consequently of the cutting disc with respect to the base, is carried out in two perpendicular directions in an X-Y plane, and in such a way that the disc always remains in a plane parallel to the longitudinal direction X of the base, in a relatively forward position, which greatly facilitates the mounting of the arm on the base and the centering of the disc in the position of use.

According to the invention, the adjustment bolt comprises between the cylindrical lower section and the cam a perimeter thickening that forms a lower stop, which acts on the lower surface of the arm during the tightening of the fastening nut for fastening the adjustment bolt to the arm.

This adjustment device comprises, at least, a locking screw for locking the arm with respect to the base once the arm has been correctly positioned on the base. Said locking screw is threadedly mounted in a threaded hole in the base and mounted through a loose hole in the arm, said screw having a washer and a tightening head on the upper surface of the arm.

According to the invention, the adjustment device comprises two adjustment bolts arranged on two opposite sides of the arm and mounted in respective holes parallel to the longitudinal direction of the base and two or more locking screws for locking the arm with respect to the base, arranged on opposite sides of the arm.

### BRIEF DESCRIPTION OF THE DRAWINGS

As a complement to the description provided herein, and for the purpose of helping to make the features of the invention more readily understandable, the present specification is accompanied by a set of drawings which, by way of illustration and not limitation, represent the following:

FIG. 1 shows a partial perspective view of a machine for cutting floor tiles with the adjustment device of the present invention.

FIG. 2 shows a partial perspective view of the area of the base intended for the mounting of the arm, one of the adjustment bolts and one of the locking screws being represented in said area and in a disassembled position.

FIG. 3 shows a partial plan view of the mounting area for mounting the arm on the base wherein the locking screws and the adjustment bolt are represented mounted only on one side of the arm, being able to see the mounting holes of said elements on the other side of the arm.

FIG. 4 corresponds to the cross section A-A referred to in FIG. 3.

FIG. 5 shows a perspective view of one of the adjustment bolts.

FIG. 6 shows a plan view of the cam of one of the adjustment screws housed in the corresponding square hole of the arm, the displacement of the square path, “T”, followed by the arm during the rotation of the cam also being schematically represented.

### DETAILED DESCRIPTION OF EMBODIMENTS OF THE INVENTION

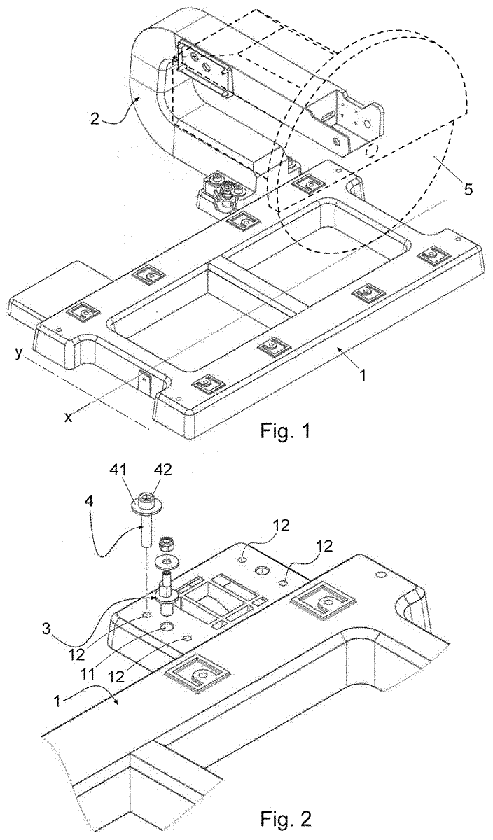

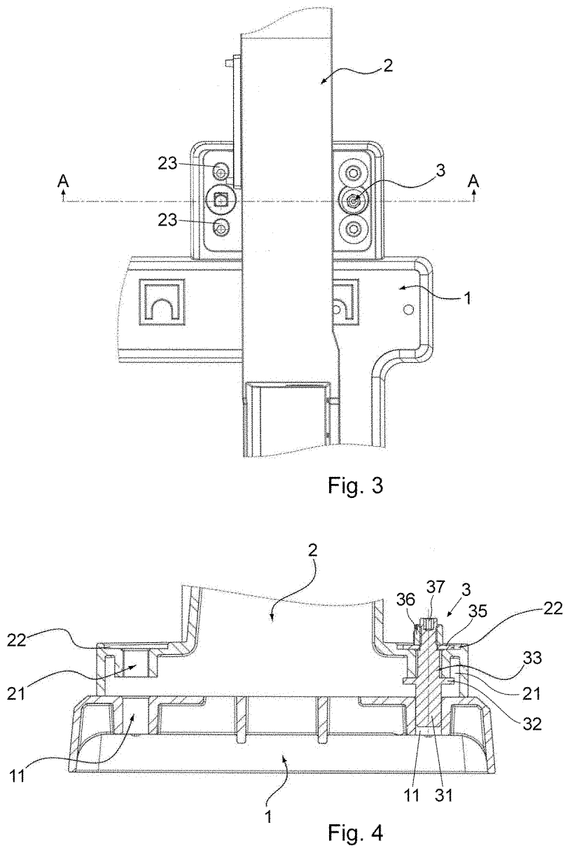

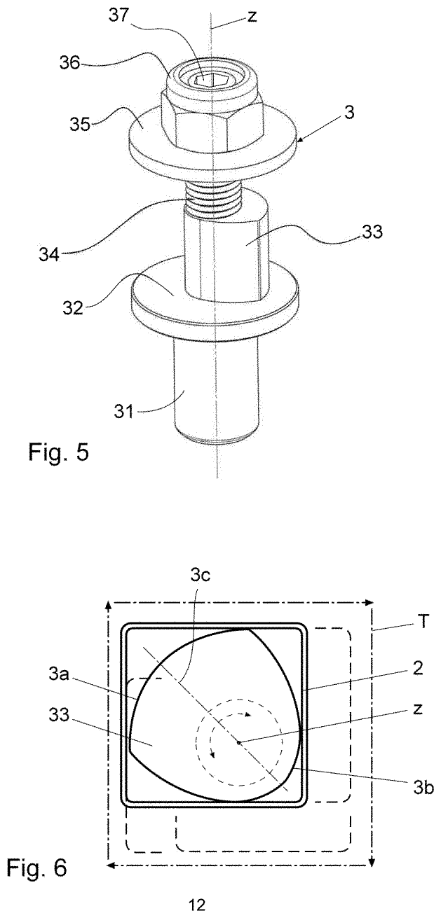

As can be seen in FIG. 1, the adjustment device for machines for cutting floor tiles is applicable to cutting machines provided with a base (1) on which the floor tiles to be cut move in a longitudinal direction (x) and an arm (2) carrying a cutting head provided with a cutting disc (5) driven by an electric motor.

The purpose of the device in question is for the user to quickly and comfortably adjust the position of the arm (2) with respect to the base (1), so that the cutting disc is centered on the base in the longitudinal direction (x).

In the example shown, the base comprises two holes (11) for rotatably mounting respective adjustment bolts (3) for adjusting the position of the arm (2) in a plane (x, y) and threaded holes (12) for mounting locking screws (4) provided with a washer (41) and a head (42), suitable for pressing the arm (2) against the base (1), immobilizing it once the position of the arm (2) has been adjusted and the cutting disc (5) is centered with respect to the base (1).

The arm (2) has on two opposite sides a square hole (21) which ends at the top in a seat (22), and holes (23) for the loose mounting of the locking screws (4) that are mounted in the threaded holes (12) of the base (1).

Each adjustment bolt (3) comprises in ascending order: a cylindrical lower section (31) rotatably housed in the corresponding hole (11) of the base on a first vertical axis (z); a perimeter thickening (32) that forms a lower support stop of the arm (2); a cam (33) defined in an intermediate area of the adjustment bolt and that acts against the inner contour of the square hole (21) in the arm (2) and a threaded upper section (34), aligned with the cylindrical lower section (31) and which protrudes at the top from the arm (2) for mounting a washer (35) and fastening nut (36) for fastening the arm (2) to the adjustment bolt (3).

To rotate the adjustment bolt (3), the threaded upper section (34) has at the end thereof a hexagonal housing (37) for coupling an actuation key.

The nut (36) acts by means of the washer (35) against the upper surface of the arm (2) and presses it against the lower stop (32), blocking the relative movement between the adjustable cam (3) and the arm (2) once said arm has been placed in the chosen position. In this position, the washer (35) is housed in the seat (22) of the arm.

As can be seen in FIG. 6, the cam (33) has a symmetrical cam profile, inscribed in the section of the square hole (21) in the arm (2); said cam profile is formed by two curved sectors (3a, 3b) of different curvature and with the axis of rotation thereof displaced toward the vertex of the curved sector (3b) of greater curvature; said cam (33) having a length in the direction of the axis of symmetry (3c) thereof, and a width in a direction perpendicular to said axis of symmetry (3c), both coinciding with the length of the side of the aforementioned square hole (21); such that the rotation of the adjustment bolt (3) causes the arm (2) to move along a square path (T) and the cutting disc (5) to be adjusted in two directions (x, y) parallel and perpendicular to the longitudinal direction (x) of the base.

In the example of FIG. 6, the curved sector (3a) of smaller curvature is a circular sector, and the curved sector (3b) of greatest curvature is an oval or elliptical sector.

Adjusting the position of the arm (2) along a square path enables the cutting disc (5) to be quickly and easily arranged in the suitable cutting position with respect to the base (1).

Once the position of the arm 2 has been adjusted, it is immobilized with respect to the adjustment bolts (3) by tightening the nuts (36) and immobilizing the assembly with respect to the base (1) by tightening the locking screws (4).

Having sufficiently described the nature of the invention, in addition to a preferred exemplary embodiment, it is hereby stated for the relevant purposes that the materials, shape, size and layout of the described elements may be modified, provided that it does not imply altering the essential features of the invention claimed below.

1. An adjustment device for machines for cutting floor tiles and similar, applicable to electrical cutting machines provided with a base (1) on which the floor tiles to be cut move in a longitudinal direction and an arm (2) carrying a head with a cutting disc (5) driven by an electric motor; said centering device comprising: an adjustment bolt (3) having: a cylindrical lower section (31) rotatably mounted in a hole (11) in the base with respect to a first axis (z) perpendicular to the base; a cam (33) defined in an intermediate area of the adjustment bolt (3) and which acts against the inner contour of a hole (21) defined in the arm (2), the rotation of the cam (33) causing the arm to move around the said first axis (z) for centering the cutting disc (5) with the base (1) and, a threaded upper section (34), aligned with the cylindrical lower section (31) and protruding at the top from the arm (2) for mounting a fastening nut (36) for fastening the arm (2) to the adjustment bolt (3) in different relative positions; wherein:
the hole (21) in the arm containing the cam (33) has a square section and,
the cam (33) has a symmetrical profile, inscribed in the square section of the square hole (21) in the arm, formed by two curved sectors (3a, 3b) of different curvature and with the axis thereof displaced toward the vertex of the curved sector (3b) of greater curvature; said cam (33) having a length, in the direction of the axis of symmetry (3c) thereof, and a width, in a direction perpendicular to the axis of symmetry (3c) thereof, of a dimension equal to the length of the side of the aforementioned square hole (21); such that the rotation of the adjustment bolt (3) causes the arm to move along a square path (T) and the cutting disc (5) to be adjusted in two directions (x, y), parallel and perpendicular to the longitudinal direction (x) of the base.

2. The device according to claim 1, wherein the adjustment bolt (3) comprises between the cylindrical lower section (31) and the cam (33) a perimeter thickening (32) that forms a lower support stop of the arm.

3. The device according to claim 1, further comprising a locking screw for locking the arm with respect to the base, threadedly mounted in a threaded hole in the base and mounted through a loose hole in the arm, said screw having a washer and a tightening head on the upper surface of the arm.

4. The device according to claim 1, further comprising two adjustment bolts arranged on two opposite sides of the arm and mounted in respective holes parallel to the longitudinal direction of the base.

5. The device according to claim 2, further comprising two adjustment bolts arranged on two opposite sides of the arm and mounted in respective holes parallel to the longitudinal direction of the base.

6. The device according to claim 3, further comprising two adjustment bolts arranged on two opposite sides of the arm and mounted in respective holes parallel to the longitudinal direction of the base.
